(19) United States
(12) Patent Application Publication
(10) Pub. No.: US 2003/0010405 A1
(43) Pub. Date: Jan. 16, 2003

(54) Magnetostrictive devices and methods using high magnetostriction, high strength fega alloys

(76) Inventors: Arthur E Clark, Adelphi, MD (US); Marilyn Wun-Fogle, Potomac, MD (US); James B Restorff, College Park, MD (US); Sivaraman Guruswamy, Salt Lake City, UT (US)

Correspondence Address: Office of Counsel Code 004, Naval Surface Warfare Center, Carderock Division Headquarters, 9500 MacArthur Boulevard, West Bethesda, MD, 20817-5700, US

(21) Appl. No.: 10/182,095

(22) PCT Filed: Jan. 29, 2001
(86) PCT No.: PCT/US01/02795

(30) Foreign Application Priority Data
Jan. 28, 2000 (US) 60178165

(51) Int. Cl. H01F 1/147

(52) U.S. Cl. 148/108; 148/306

(57) ABSTRACT

Devices and methods employ FeGa alloys having excellent magnetostriction and good strength. Additionally, methods of producing preferentially oriented FeGa alloys are described.

### BACKGROUND OF THE INVENTION

1. Field of the Invention

The present invention relates generally to magnetostrictive devices and methods and more specifically to magnetostrictive device and methods using shock-resistant magnetostrictive alloys.

2. Description of the Background Art

With the emergence of smart material technology, a need has arisen for rugged, inexpensive, highly magnetostrictive materials which have the ability to transduce large energies under high compressive stresses. Common metals, such as iron, numerous iron alloys and steels, possess good mechanical properties and the ability to withstand shock environments, but have very low magnetostrictions (˜10⁻⁵ to ˜10⁻⁴), with many alloys having magnetostrictions near the lower value. Terfenol-D, various high magnetostriction rare earth-Fe₂ compounds, and single crystals of modified cobalt ferrite possess huge magnetostrictions (>10⁻³) at room temperature, but are, in general, brittle and unable to withstand appreciable tensile stresses. To fill the gap between these materials, attempts have been made to synthesize magnetostrictive composites using highly magnetostrictive Co ferrite or rare earth-Fe₂ with some type of binder.

### SUMMARY OF THE INVENTION

Accordingly, it is an object of this invention to provide a highly magnetostrictive material with good physical strength.

It is another object of this invention to provide a shock-resistant, highly magnetostrictive material.

It is a further object of the present invention to provide a highly magnetostrictive material with sufficient strength to be used as a structural member.

These and other objects of the present invention are accomplished by magnetostrictive devices and methods using an Fe-based alloy having 70 at % to about 90 at % Fe, about 5 at % to about 30 at % Ga, and, optionally, one or more additional non-magnetic metals such as Al.

### BRIEF DESCRIPTION OF THE DRAWINGS

A more complete appreciation of the invention will be readily obtained by reference to the following Description of the Preferred Embodiments and the accompanying drawings in which like numerals in different figures represent the same structures or elements, wherein:

FIG. 1 schematically illustrates a typical device according to the present invention.

FIG. 2 is a chart showing the composition of various FeGaAl alloys. Points marked with a “●” show single crystal compositions examined in the EXAMPLES section which follows, and compositions marked with a “▪” show prior art compositions measured by Hall, J. Appl. Phys. 30, (1959) 816-919; J. Appl. Phys. 31 (1960), 1037-1038.

FIG. 3a and FIG. 3b show room temperature magnetostriction and magnetization, respectively, of [100] Fe₈₃Ga₁₇ as a function of internal magnetic field (H) for compressive loadings of 10.3 to 96.5 MPa. The internal field (H) was calculated using a demagnetization factor of N=0.0075.

FIG. 4a and FIG. 4b show room temperature magnetostriction and magnetization, respectively, of [100] Fe₇₉Ga₂₁ vs. internal magnetic field (H) for compressive loadings of 15.5 to 145.8 MPa. The internal field (H) was calculated using a demagnetization factor of N=0.0060.

FIG. 5a and FIG. 5b show room temperature magnetostriction and magnetization, respectively, of[100] Fe₈₇Ga₄Al₉ vs. internal magnetic field (H) for compressive loadings of 19.9 to 120 MPa. The internal field (H) was calculated using a demagnetization factor of N=0.0067.

FIG. 6 shows 3/2λ₁₀₀ and 3/2λ₁₁₁ as a function of temperature for Fe₈₇ and Ga₁₃ and Fe₈₃Ga₁₇ at H=20kOe. Magnetization data for Fe₈₂Ga₁₈ was taken from Kawamiya et al. , Phys. Soc. Japan 33, (1972), 1318-1327.

FIG. 7 shows the Vickers hardness for a Ga—Al based alloy according to the present invention.

FIGS. 8 through 15 provide information on texture evolution with texture anneal at 1150° C. and 1300° C.

FIGS. 16a and 16b schematically illustrate devices and methods used to obtain polycrystalline FeGa alloys.

FIG. 17 shows magnetostriction observed at different prestress levels in Fe-15 at % Ga directionally grown alloy rods grown at a rate of 22.5 mm/h.

FIG. 18 shows magnetostriction observed at different prestress levels in Fe-20 at % Ga directionally grown alloy rods grown at a rate of 22.5 mm/h.

FIG. 19 shows magnetostriction observed at different prestress levels in Fe-15 at % Ga directionally grown alloy rods grown at a rate of 203 mm/h.

FIG. 20 shows magnetostriction observed at different prestress levels in Fe-27.5at % Ga directionally grown alloy rods grown at a rate of 22.5 mm/h.

FIG. 21 compares the observed saturation magnetostriction for various FeGa alloys obtained according to a variety of methods.

FIGS. 22 through 25 show magnetostriction values obtained in Fe-27.5% Ga DS cast alloys after various long-ordering treatments.

FIG. 26 summarizes the data shown in FIGS. 22 through 25.

FIG. 27 shows the magnetostriction curves for Fe-15 at % Ga-5 at % Al directionally grown (DG) alloy rod (grown at 22.5 m/h) at different prestress levels.

FIG. 28 shows the magnetostriction curves for Fe-10 at % Ga-10 at % Al DG alloy rod grown at 22.5 mm/h at different prestress levels.

FIG. 29 shows the magnetostriction curves for Fe-5 at %Ga-15 at % Al DG alloy rod grown at 22.5 mm/h at different prestress levels.

FIGS. 30 through 33 shows the magnetostriction curves for various DG alloy rods grown at 22.5 mm/h at different prestress levels.

FIG. 34 summarizes the results of the work on the influence of partial substitution of Ga by Al in Fe—Ga alloys.

### DESCRIPTION OF THE PREFERRED EMBODIMENTS

The magnetostrictive alloys used in the magnetostrictive device and method of the presently claimed invention are based upon the α-iron structure and have a room temperature saturation magnetostriction along the [100] axis of at least about 200 ppm, typically about 250 ppm or more, and often about 300 or more. While it is not intended to be bound by theory, it appears that Ga and other nonmagnetic metals such as Al substitute for iron in the crystal lattice, distorting the lattice and consequently enhancing the magnetostrictive properties of the material. It appears that the distribution of the added Ga and nonmagnetic metal is non-random, exhibiting some short-range order. Thus, the crystalline structure of the alloys of the present invention may be a hybrid, or perhaps even a multiphase mixture, of the α-iron phase, the DO₃ phase, and, possibly, the Ll₂ phase.

The alloys used in the present invention should include at least about 5 at % Ga in order to assure significant enhancement of magnetostrictive properties. The effects of Ga (or a mixture of Ga and an additional nonmagnetic metal) upon the magnetostrictive performance of the alloys according to the present invention vary parabolically depending upon concentration. To achieve maximum magnetostriction, the concentration of Ga+Al should be as high as possible without introducing significant concentrations of secondary phases that lower magnetostriction. The concentration of Ga+Al at which peak magnetostriction occurs varies depending upon how the alloys is formed. When the alloy is formed by furnace cooling a melt including Fe, Ga, and optionally, nonmagnetic metal, peak magnetostriction occurs at about 15-17 at % Ga+additional nonmagnetic metal. With rapid quenching rather than furnace cooling, peak magnetostriction occurs at about 19 at % Ga+ additional nonmagnetic metal. In all cases, magnetostrictive performance drops sharply as one move away from the optimum concentration of Ga (or Ga+additional nonmagnetic metal).

The magnetostriction of the alloys used in the present invention is also optimized when the alloy is Fe+Ga, i.e., when the alloy does not include an additional nonmagnetic metal. The additional nonmagnetic metal, such as Al, also increases the magnetostriction of the alloys, its effect is significantly less than that of Ga. However, the additional nonmagnetic metal may effectively substitute for Ga in order to reduce cost, with a corresponding decrease in magnetostriction. Depending upon the intended use for the alloy, the price differential may make the decreased magnetostriction acceptable.

Impurities and additives may also be present in the alloys of the present invention. These impurities and other additional metals may be present as long as they do not significantly lower the magnetostriction of the alloys. Typically, impurities and other additional metals are acceptable in amounts of 2 at % or less, and, more often, in amounts of 1 at % or less.

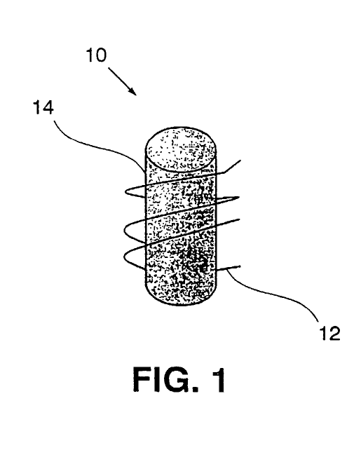

FIG. 1 schematically illustrates a typical device 10 according to the present invention. Electromagnetic winding 12 is coiled about core 14 of the above-described magnetostrictive alloy. The device exhibits two modes of operation. In its actuator mode, current flowing through winding 12 generates a magnetic field. This magnetic field acts upon core 14, causing dimensional changes along at least one axis thereof. In the current generating mode, force applied along an axis of core 14 changes the dimensions thereof. This change in dimensions magnetostrictively changes the magnetic field to which coil winding 12 is exposed. That changing magnetic field generates a current within winding 12.

Several different methods allow one to obtain polycrystalline alloys according to the present invention. For example, directional growth methods (such as the Bridgeman method) typically used for single crystal growth may be modified so that crystal growth occurs at rates significantly greater than those typically used for single crystal growth. Such a method typically provides a polycrystalline material with a mixture of [100] and [110] crystals, and good magnetostriction. While this method is faster than single crystal growth, it is still relatively expensive.

Preferential alignment of polycrystalline material according to the present invention, which should result in good magnetostrictive properties, has also been obtained using a sequence of hot rolling, two stage warm rolling with intermediate anneal and extended final texture anneal at a temperature in the range of 1150° C. to 1300° C. Hot rolling is carried out preferably in the temperature range of 1050° C. to 1150° C. Warm rolling temperatures are generally about 350° C. or higher, usually at or above 375° C., and preferably about 400° C. Warm rolling temperatures up to about 550° C. may be used but lower temperatures are preferred. The amount of reduction in each stage is generally than about 22% or more, and more often about 30% or more, with preferred reductions in each stage being 60-65%. Higher reductions tend to cause cracking and are best avoided. The most preferred temperature range is 1150° C.-1200° C. and annealing times are preferably about 24 hours. This rolling and annealing method generally requires small amounts a carbide and/or other texturing additive to control the grain growth and favor the development of [001] orientation. NbC, for example, produce (Fe-15 at %Ga)₉₉(NbC)₁ polycrystalline alloy material with [001] preferred orientation. For texturing additives, one may also use other carbides such as NbC, TiC, VC, sulfides such as MnS, nitrides, or carbonitrides that will dissolve at high solutionizing temperatures and reprecipitate at the hot rolling temperature resulting in higher compressibility and good control of grain growth and therefore small grain sizes. Amount of texturing additives are typically less than a fraction of a percent.

The above-described methods of producing preferentially aligned FeGa according to the present invention are further described in the EXAMPLES section of this application, and in Scripta mater. 43 (2000) 239-244, the entirety of which is incorporated herein for all purposes.

Having described the invention, the following examples are given to illustrate specific applications of the invention including the best mode now known to perform the invention. These specific examples are not intended to limit the scope of the invention described in this application.

### EXAMPLES

Single Crystal Preparation

Measured quantities of aluminum (99.999% pure), gallium (99.999% pure) and electrolytic iron (99.99% pure) were cleaned and arc melted together several times under an argon atmosphere. The resulting buttons of 40 g were remelted and the alloy drop-cast into a Cu chill cast mold to obtain compositional homogeneity. Next, the as-cast ingot was inserted into an alumina crucible, heated undervacuum up to 600° C. for degassing. The furnace was then backfilled with argon and the temperature increased to 1650° C. The ingot/crucible was stabilized for 1 hour at this temperature and then withdrawn at a rate of 2 nm/hr.

Following crystal growth, the samples were annealed at 1000° C. for 72 hours and furnace cooled. The as-grown crystals were oriented along the [100] and [110] directions within 1° using back reflection Laue diffraction and finally cut into thin discs and ¼″ dia.×˜1″ long rods for magnetostriction, magnetization, and elastic moduli measurements.

Magnetization and Magnetostriction of Fe—Ga and Fe—Ga—Al Single Crystals Under Compressive Stress

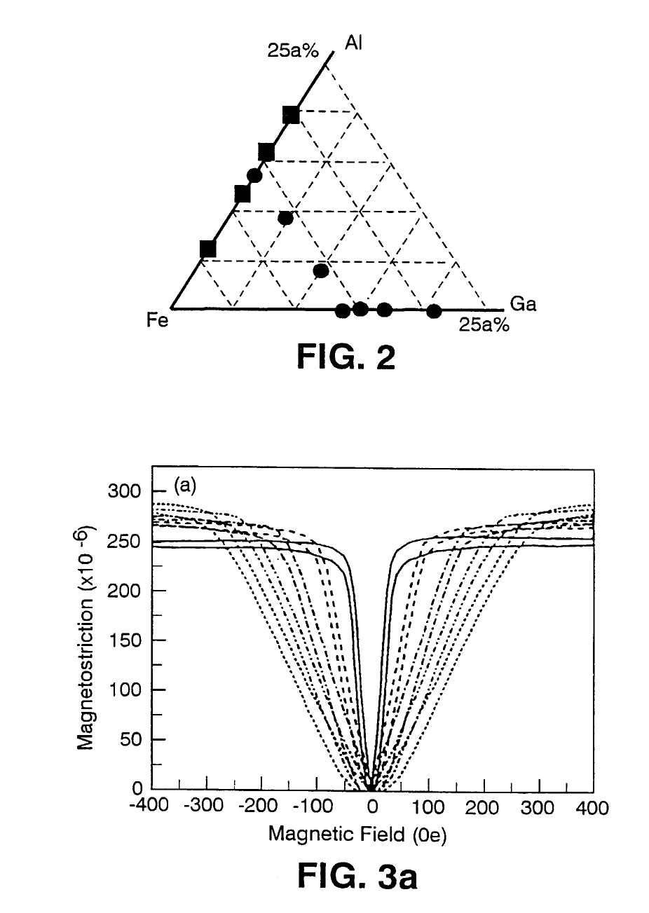

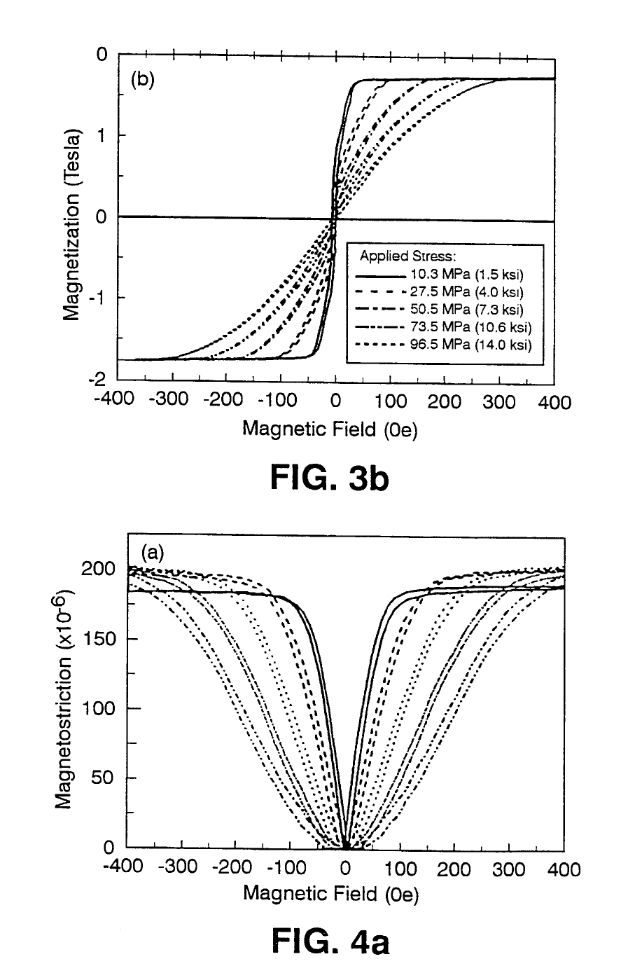

A conventional dead-weight apparatus was used to apply compressive loads to the samples indicated in FIG. 2. Magnetic fields up to 1 kOe were applied to the samples from a solenoid energized by a constant current source. The magnetizations were calculated from the emf generated by a small pick-up coil surrounding the center of the sample. Displacements were determined from the output of three linear variable differential transformers (LVDT's) and two or more strain gages. Typical room temperature strain and magnetization data under compressive loads are shown in FIG. 3, 4, and 5.

FIG. 3 illustrates the fractional change in length of [100] single crystal Fe₈₃Ga₁₇ in fields up to 400 Oe and compressive stresses up to 96 MPa. Note that the magnitude of the saturation magnetostrictions are ˜10× those of Fe and ˜2× those of Fe₈₅Al₁₅. The large saturation magnetization of ˜1.8 T (FIG. 3b), helps to achieve these large strains at readily attainable fields, even under stresses greater than 90 MPa. In addition to the high saturation magnetization, the b.c.c. Fe₁₀₀₋ₓGaₓ alloys (x<20) possess [100] easy axes, which also aids the rapid saturation of magnetization and magnetostriction. Estimating the magnetic anisotropy using a simplified expression for the energy: E=Mₛ·H+K₁(α₁²α₂²+c.p.)+(3/2)λ₁₀₀σ(α₁²β₁²+c.p.), yields K₁≅10⁴ Joules/m³. (Mₛ is the saturation magnetization; H, the applied field; K₁, the lowest order cubic magnetic anisotropy constant; σ is the compressive stress along the [100] direction, α₁ and β₁ (i=1 to 3) are, respectively, the direction cosines of the magnetization and strain measurement direction with respect to the crystal axes.)

Table I illustrates how the average values of piezomagnetic constant (d₃₃) and permeability (μₘₑₐₛ) for this sample depend upon compressive stress. Theoretical values of permeability (μ_{calc}) calculated from the energy transduction relation, MₛHₛ=2σλ, where Hₛ is the field for saturation, σ is the compressive stress, and λ is the saturation fractional change in length (3λ₁₀₀/2), are also included (μ_{calc}=Mₛ²/2σλ+1). Note that except for the lowest stress μₘₑₐₛ>μ_{calc}, probably due to the positive value of K₁.

TABLE I
PIEZOMAGNETIC d₃₃ CONSTANT AND
PERMEABILITY OF FE₈₃GA₁₇
UNDER COMPRESSIVE STRESS AT ROOM TEMPERATURE

| σ(MPa | d₃₃ (nm/A) | μₘₑₐₛ | μ_{calc} |
|---|---|---|---|
| 16.0 | 58 | 285 | 290 |
| 27.5 | 34 | 174 | 167 |
| 39.0 | 29 | 133 | 117 |
| 50.5 | 22 | 108 | 90 |
| 62.0 | 20 | 91 | 73 |
| 73.5 | 18 | 78 | 61 |
| 85.0 | 16 | 70 | 52 |
| 96.5 | 15 | 61 | 45 |

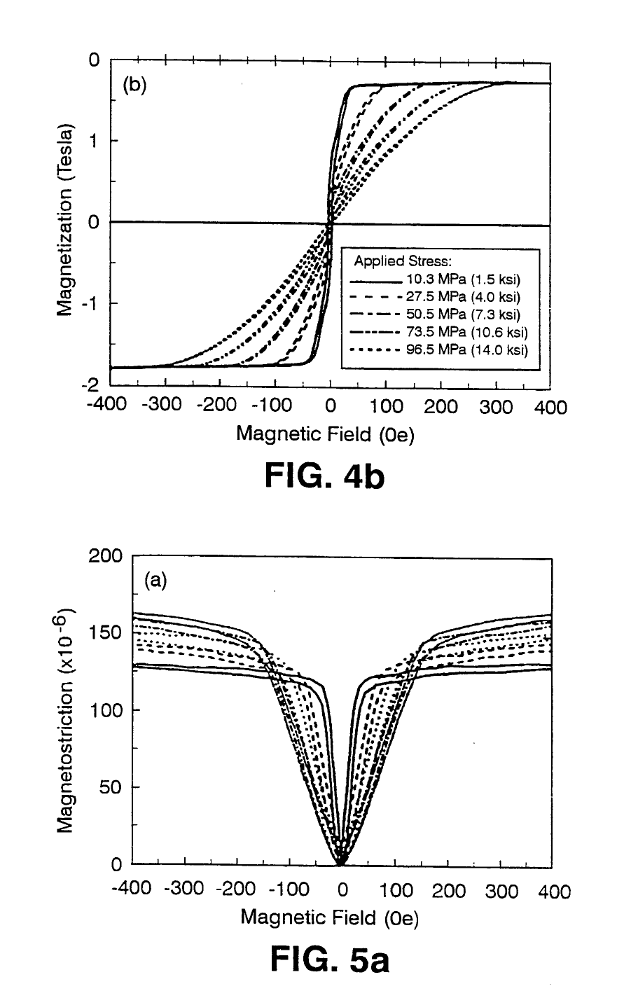

The magnetostriction and magnetization of Fe₇₉Ga₂₁ under large compressive stresses is given in FIG. 4. While the field dependencies in this figure resemble those of Fe₈₃Ga₁₇ in FIG. 3a and FIG. 3b, both the saturation magnetostriction and magnetization are lower. The maximum room temperature magnetostriction in the binary Fe₁₀₀₋ₓGaₓ occurs for 15<x<21.

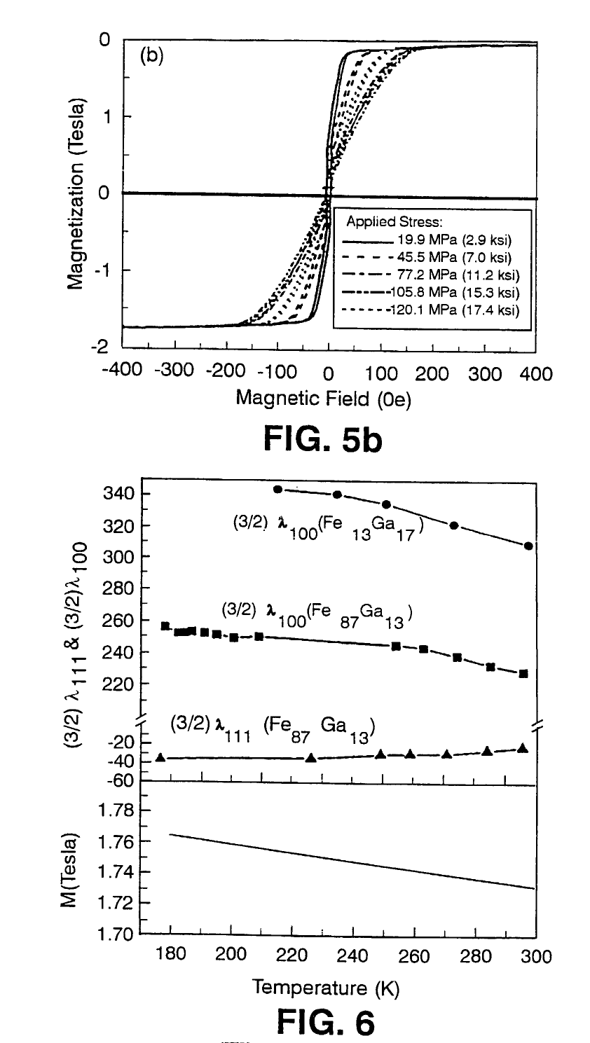

FIG. 5 shows the magnetization and magnetostriction vs. field curves for the ternary Fe₈₇Ga₄Al₉ alloy for compressive stresses up to 120 MPa. Replacing 1/3 of the aluminum in the nominal Fe₈₅Al₁₅ alloy by Ga increases λ₁₀₀ by ˜27%. Because the magnetostriction is lower in this alloy than that in the binary Fe—Ga alloy of FIG. 4, the magnetic fields required for saturation are lower and permeabilities are larger. Similar results are found for the Fe₈₆Ga₁₀Al₄ alloy, but are not reported here.

Temperature Dependence of the Magnetostriction Constants

Thin (100) and (110) discs of the single crystal samples were cut from larger crystals and mounted in a cryostat for measurements of the saturation magnetostriction constants below room temperature. Constantan foil strain gages were attached along the [100] and [111] directions for the measurement of λ₁₀₀ and λ₁₁₁. Strains measured as a function of angle between the strain gage direction and magnetic field direction showed that the magnetostriction indeed follows the simple cos²θ angular dependence within ˜1%. No higher order terms were evident. FIG. 6 shows the temperature dependence of the magnetostriction constants from −95° C. to room temperature at 20 kOe. Also plotted on the figure is the temperature dependence of the saturation magnetization for a b.c.c. Fe₈₂Ga₁₈ alloy, taken from Kawamiya, N., K. Adachi, and Y. Nakamura, J. Phys. Soc. Japan 33, (1972), 1318-1327. Comparison of these data over this limited temperature range shows that the λ₁₀₀ magnetostriction decreases with temperature at a rate slightly greater than Mₛ(T)³. There is no evidence of the anomalous ‘dip’ in the magnetostriction observed in the λ₁₀₀ constant of simple b.c.c. Fe. Some room temperature magnetostriction constants for various Fe-based alloys are compared in Table II.

TABLE II
ROOM TEMPERATURE VALUES
OF λ₁₀₀ AND λ₁₁₁ FOR SOME FE-BASED ALLOYS

| Atomic % in Fe | λ₁₀₀(× 10⁻⁶) | λ₁₁₁(× 10⁻⁶) |
|---|---|---|
| Fe₈₃Ga₁₇ | 207 | — |
| Fe₈₇Ga₁₃ | 153 | −16 |
| Fe₈₄Al₁₆* | 86 | −2 |
| Fe_{84·4}Cr_{15·6}* | 51 | −6 |
| Fe_{84·4}V_{15·6}* | 43 | −10 |

*Taken from R. C. Hall, J. Appl. Phys. 30, (1959) 816-819; J. Appl. Phys. 31 (1960), 1037-1038.

Elastic Moduli and Magnetoelastic Energies

In order to determine the magnitude of the magnetoelastic energy as well as to evaluate the technological usefulness of this alloy system, it is important to know some elastic moduli, in particular Young's modulus, Poisson's ratio, and the shear elastic constant, c₁₁−c₁₂. Note that the lowest order magnetoelastic energies for cubic crystals are given by: B₁=−(3/2)(c₁₁−c₁₂)λ₁₀₀ and B₂=−3c₄₄λ₁₁₁. Clearly, for these Fe-based alloys, B₁ represents the major magnetoelastic component.

For [100] oriented magnetostrictive rods, the elastic constants c₁₁ and c₁₂ can be calculated from Poisson's ratio (p) and Young's modulus (Y) measurements through the following relationships:

c₁₁=[(1−p)/(1+p)(1−2p)]Y and

c₁₂=[p/(1+p)(1−2p)]Y,

from which: C₁₁−c₁₂=Y/(1+p).

Young's modulus and Poisson's ratio were measured as a function of magnetic field on a sample of Fe₈₅Ga₁₅ at room temperature. The stiff (low field, high stress) Young's modulus is ≅77 GPa and Poisson's ratio is ≅0.38. Magnetoelastic energies and moduli for Fe₈₃Ga₁₇, Fe₈₄Al₁₆, Fe₉₆Al₄ and Fe are compared in Table III.

TABLE III
ELASTIC AND MAGNETOELASTIC
CONSTANTS AT ROOM TEMPERATURE.

| | (3/2)λ₁₀₀(× 10⁻⁶) | c₁₁-c₁₂ (GPa) | B₁(× 10⁶J/m³) |
|---|---|---|---|
| Fe₈₃Ga₁₇ | 311 | 56* | −17 |
| Fe₈₄Al₁₆** | 129 | 65 | −8.4 |
| Fe₉₆Al₄** | 36 | 88 | −3.2 |
| Fe** | 30 | 96 | −2.9 |

*From Fe₈₅Ga₁₅ sample,
**Hall, R. C., J. Appl. Phys. 30, (1959) 816-819; J. Appl. Phys. 31 (1960), 1037-1038 and Leamy, H., E. D. Gibson, and F. X. Kayser, Acta Metallurgica, 15, (1967), 1827-1837,
***From Hall, R. C., J. Appl. Phys. 30, (1959) 816-819; J. Appl. Phys. 31 (1960), 1037-1038 and Mason, W. P., “Physical Acoustics and the Properties of Solids,” D. Van Nostrand Publ. Co. New York (1958), p. 358

Hardness and Tensile Strength

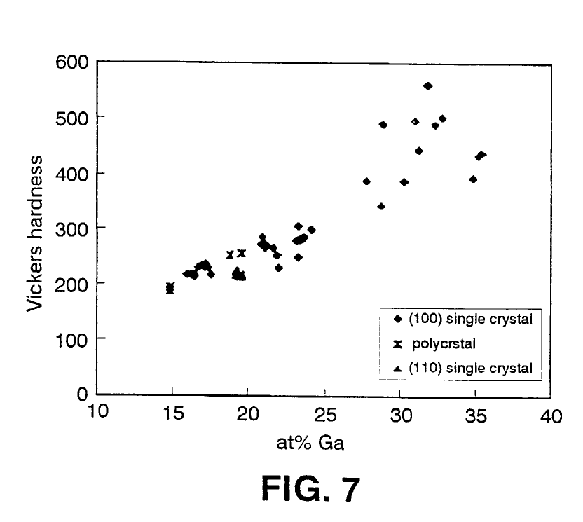

The addition of Ga to Fe was found to increase the hardness of both polycrystal and single crystal samples. Vicker's hardness values calculated from measurements taken on alloys of Fe₁₀₀₋ₓGaₓ for 0<x<35 are shown in FIG. 7. For the magnetostrictive materials described in the above sections, where 15<x<20, the hardness ranges between 200 and 250. These values imply rugged, moderately ductile material with tensile strengths ˜700 MPa (100,000 psi).

Polycrystalline Textured FeGa Alloys

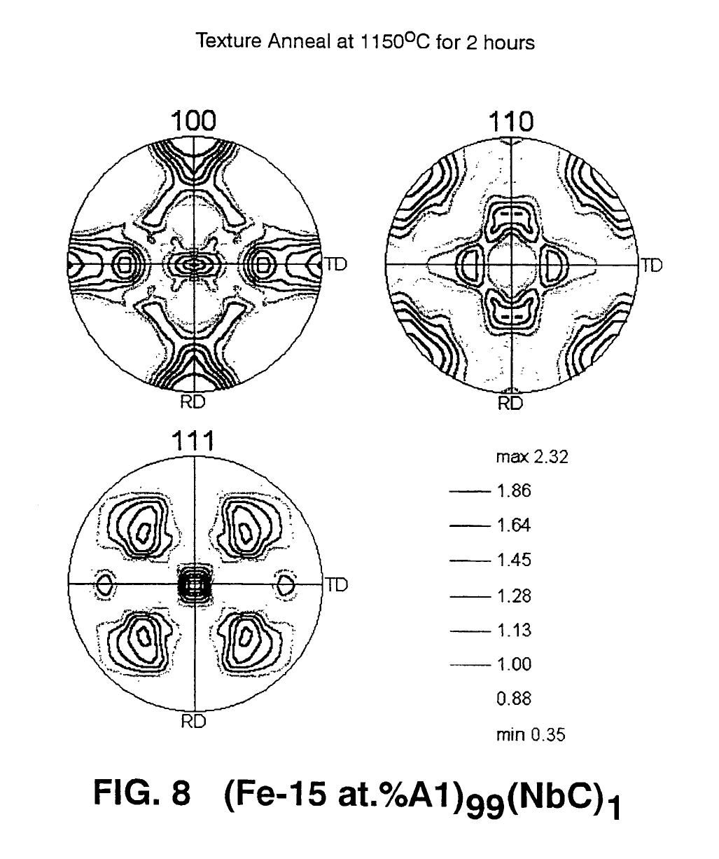

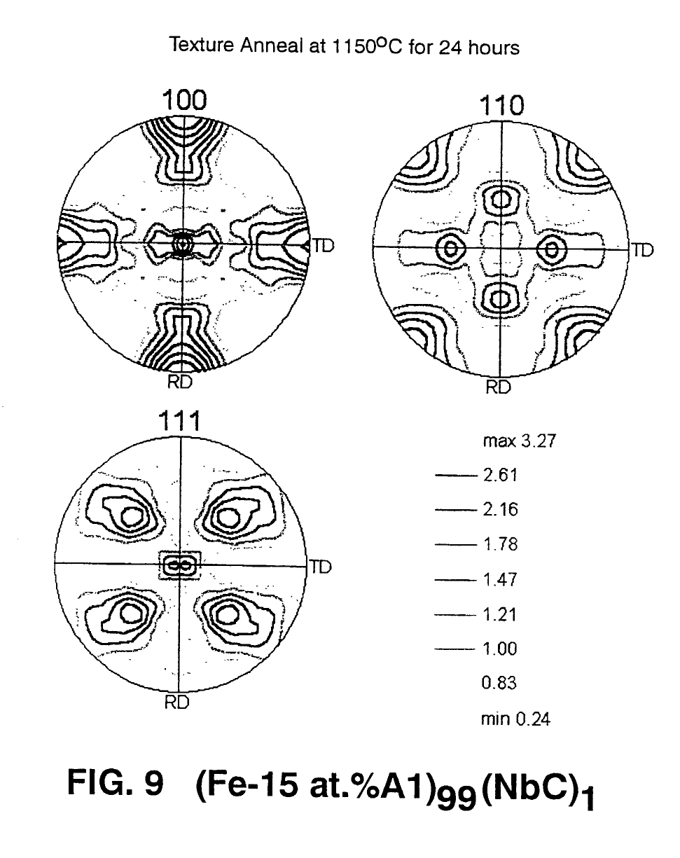

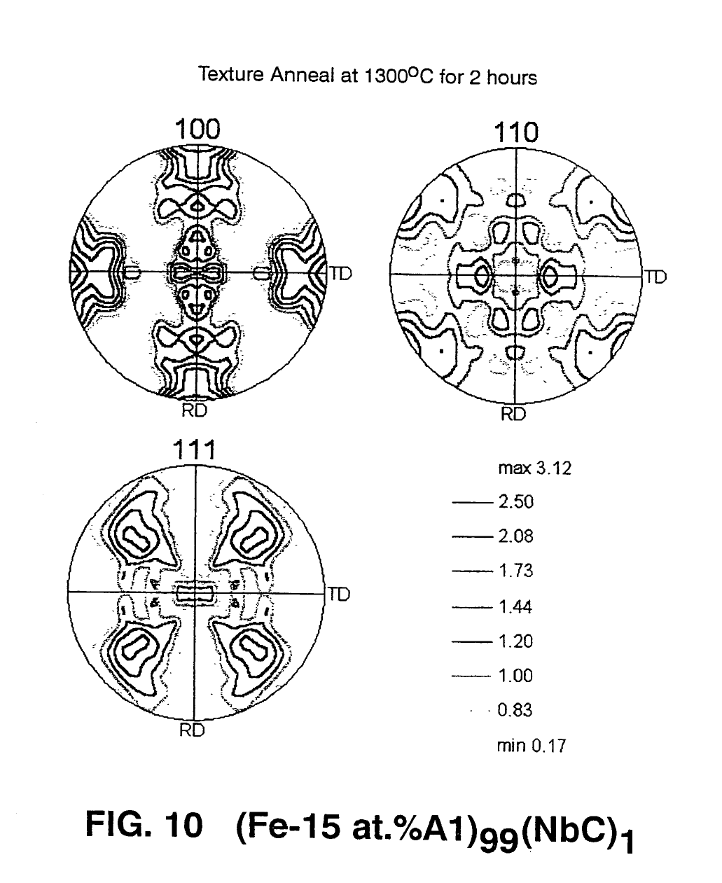

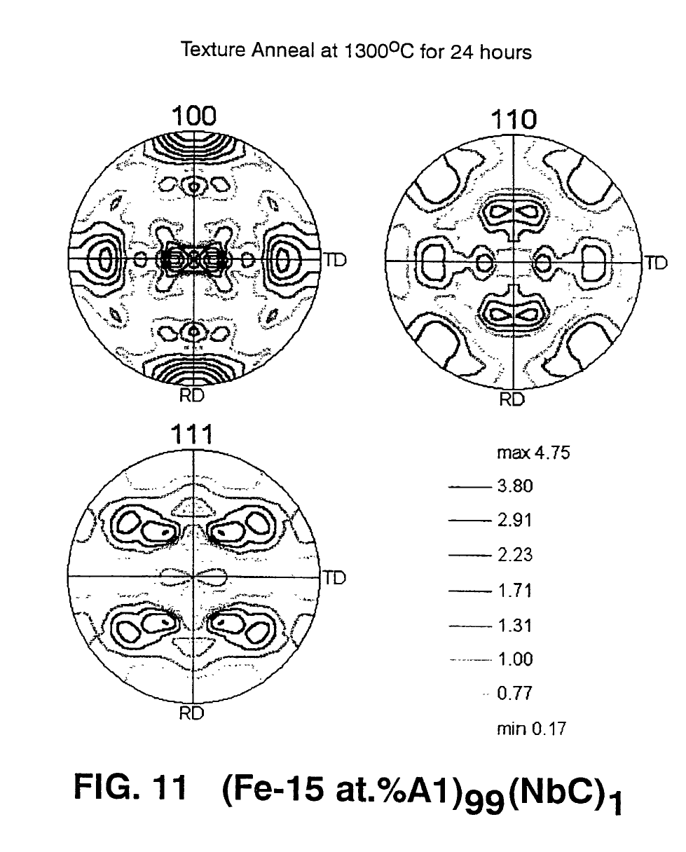

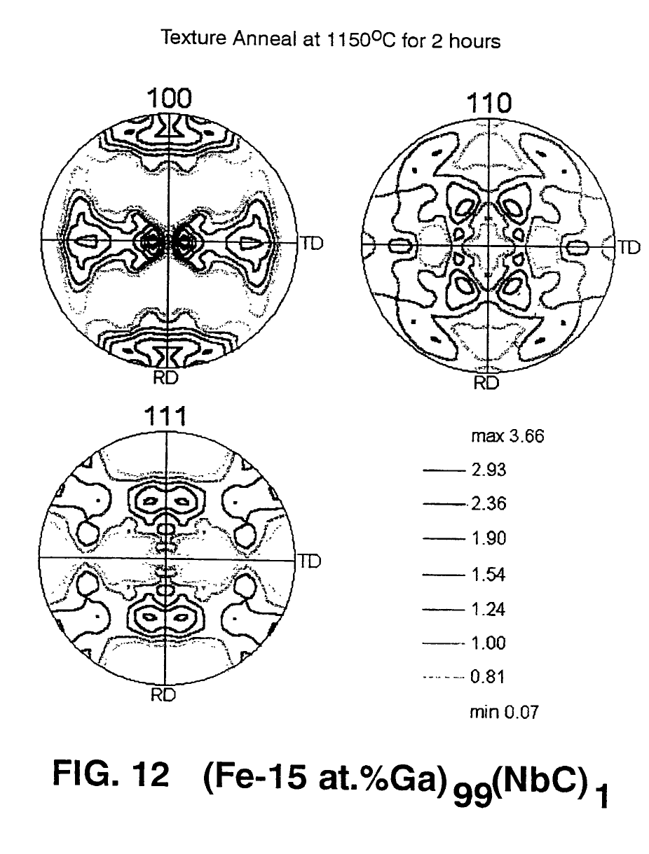

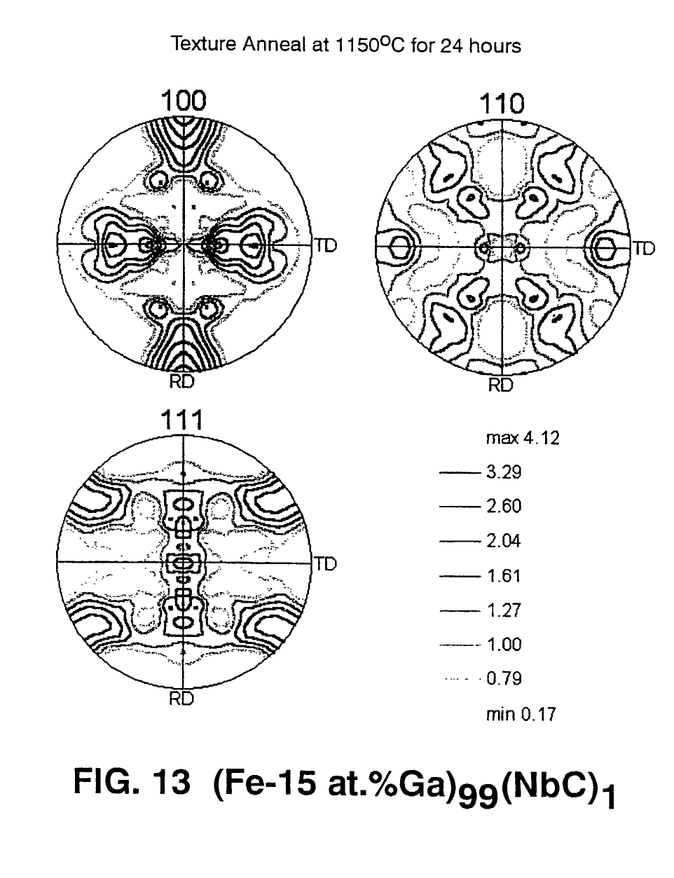

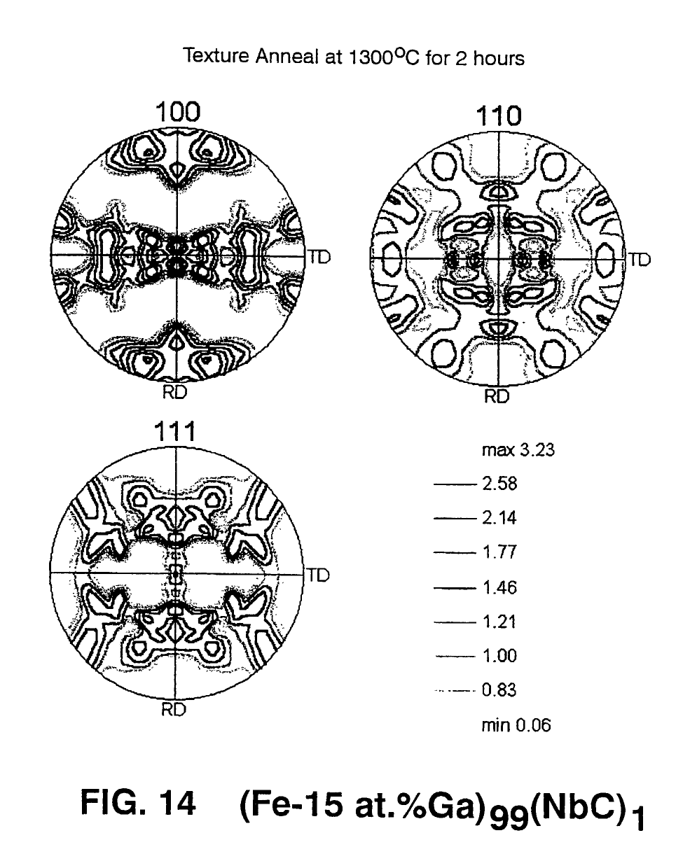

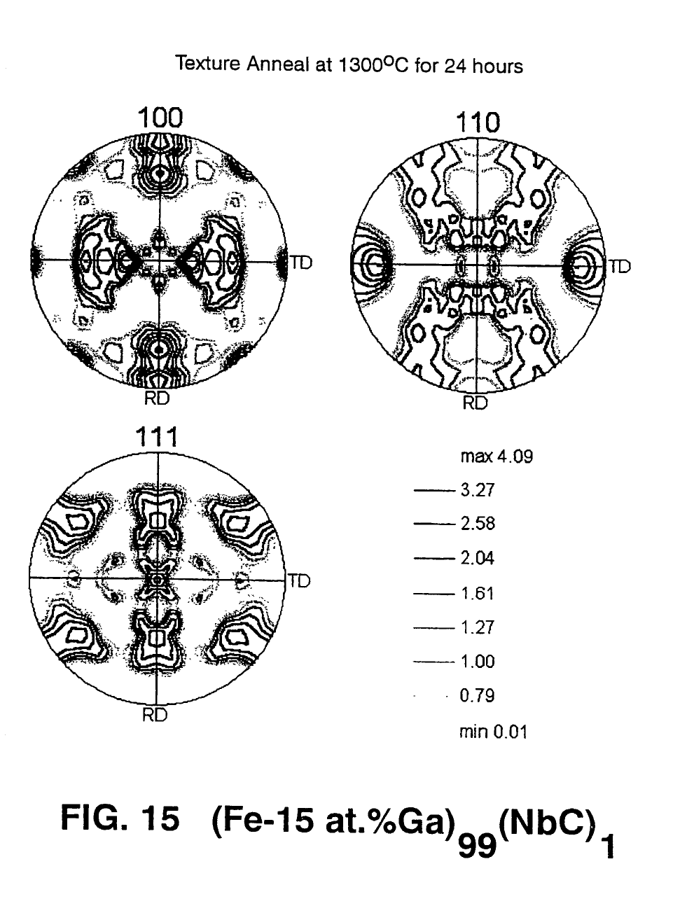

This example shows that inexpensive processing conditions may be used to obtain material with preferred [001] crystallographic texture, direction along which maximum magnetostriction can be obtained. A sequence of hot rolling, two stage warm rolling with intermediate anneal at 900° C. for 1 hour, and extended final texture anneal at a temperature in the range of 1150° C. to 1300° C. produces (Fe-15 at %Ga)₉₉(NbC)₁ polycrystalline alloy material with [001] preferred orientation. The warm rolling reductions used were between 60 and 65% in each of the two steps. Texture obtained is very sensitive to processing conditions and composition. Longer texture anneal times and higher temperatures provide improved [001] texture. Corresponding Fe—Al based alloy requires a higher temperature for texture anneal to obtain [001] texture. Orientation imaging microscopy (OIM) technique was used to examine the evolution of texture. Pole figures in FIGS. 8 through 15 provide information on texture evolution with texture anneal at 1150° C. and 1300° C. Each of these figures corresponding to a given texture anneal condition is obtained by determining the orientation of each grain on a section normal to the rolling direction using OIM technique in SEM. The [001] pole figure shows the distribution of [001] direction of the grains, using contour maps. The [110] pole figure shows the distribution of [110] direction of the grains, using contour maps. The [111] pole figure shows the distribution of [111] direction of the grains, using contour maps. A combination of these three plots corresponding each annealing treatment is used to interpret the nature of texture in each sample. It is observed from these figures that a sequence of hot rolling, two stage warm rolling with intermediate anneal at 900° C. for 1 hour, and extended final texture anneal at a temperature in the range of 1150° C. to 1300° C. produces (Fe-15 at %Ga)₉₉(NbC)₁ polycrystalline alloy material with [001] preferred orientation.

The textured Fe—Ga alloys made using the above processing method provide an inexpensive and very attractive alternative to existing rare earth based giant magnetostrictive materials. They will be cheaper than corresponding single crystal or directionally solidified textured materials and can be produced in larger quantities. The current invention provides processing conditions that will result in desired [001] texture.

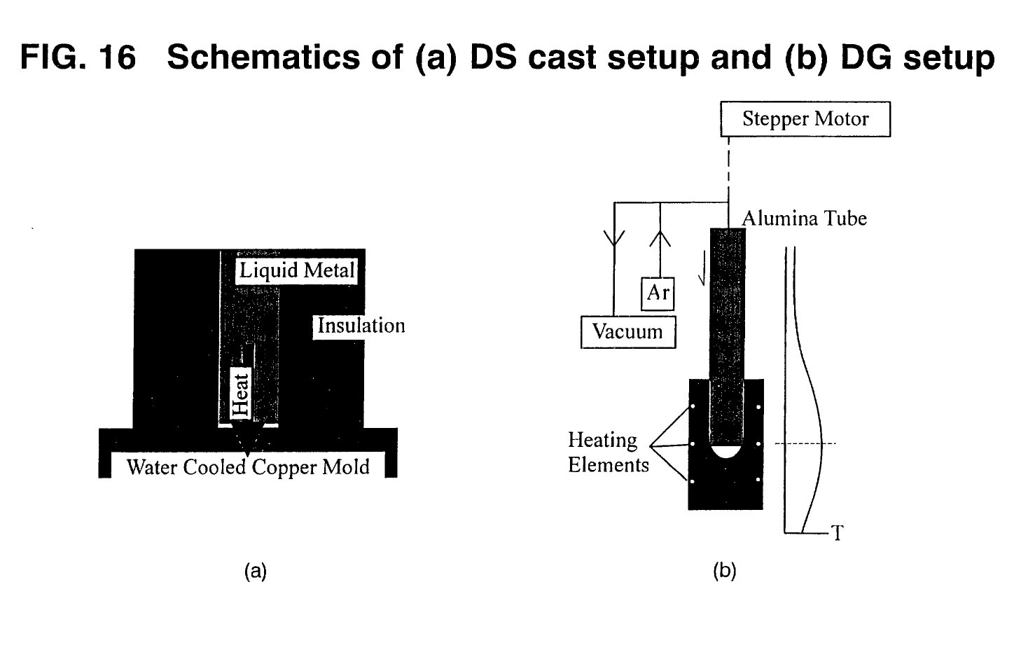

Polycrystalline Fe—Ga alloys containing Ga in the range of 15 to 27.5 at % Ga enhances magnetostriction in Fe to values in the range of 70×10⁻⁶ to 271×10⁻⁶. These Fe—Ga alloys were obtained by allowing arc-melted alloys to flow into a cylindrical mold with a water-cooled Cu surface at the bottom and insulated cylindrical surface (FIG. 16a). Rapid one dimensional heat extraction from the melt occurred by heat flow primarily occurring in the downward direction in to the water-cooled Cu block. No control of rate of solid-liquid interface movement was possible in this arrangement. These alloys are hereafter referred to as DS cast alloys.

To improve the control on the rate of solid-liquid interface movement (interface velocity), a solidification scheme shown in FIG. 16(b) was used. The alloys were prepared by arc melting and cast in to rods approximately 6 or 9 mm in diameter. The rods were then placed in a long closed-one-end alumina tube with a Kwik-Flange coupling at the open end allowing connection to vacuum/inert gas lines. The tube is evacuated and backfilled with argon. The tube is then positioned in a resistance heated SiC tube furnace with the sample centered in the maximum temperature region. The tube is then heated to a set-maximum temperature allowing the alloy rods to melt. After ensuring the completion of the melting process, the tube is lowered at a controlled rate down the furnace tube using a stepper motor-drive mechanism. As the tube moves down the temperature profile, solidification of the melt starts from the bottom end of the tube. Nucleated crystals with preferred growth direction along the tube-axis tend to dominate. Samples show mixed texture between [110] and [100]. The alloy rods processed by this technique are referred to as directionally grown or DG alloy rods.

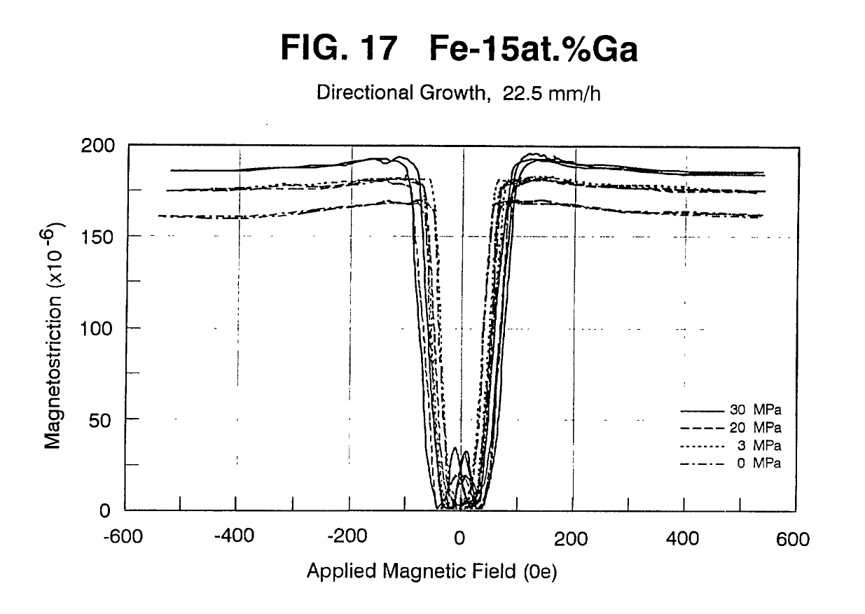

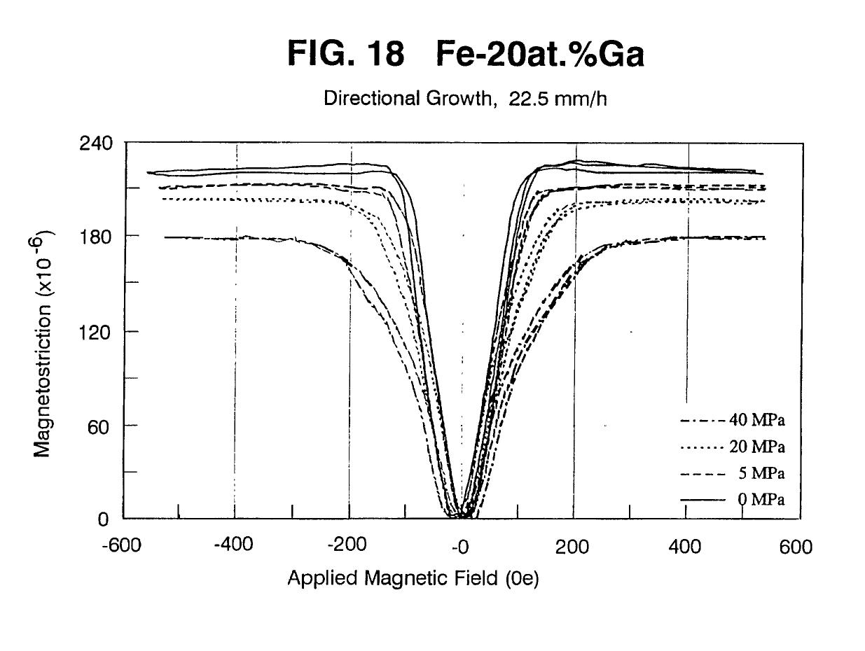

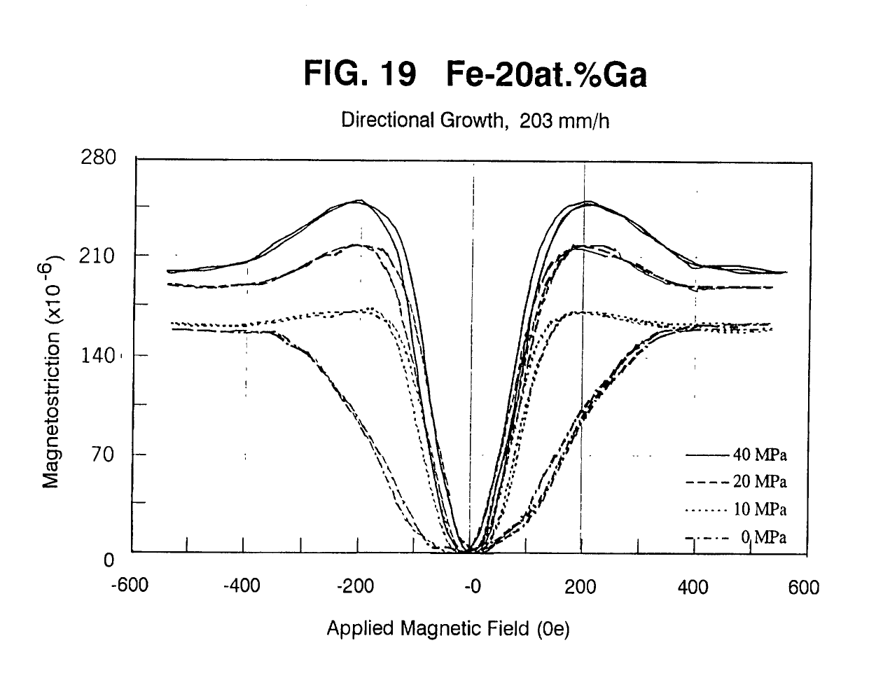

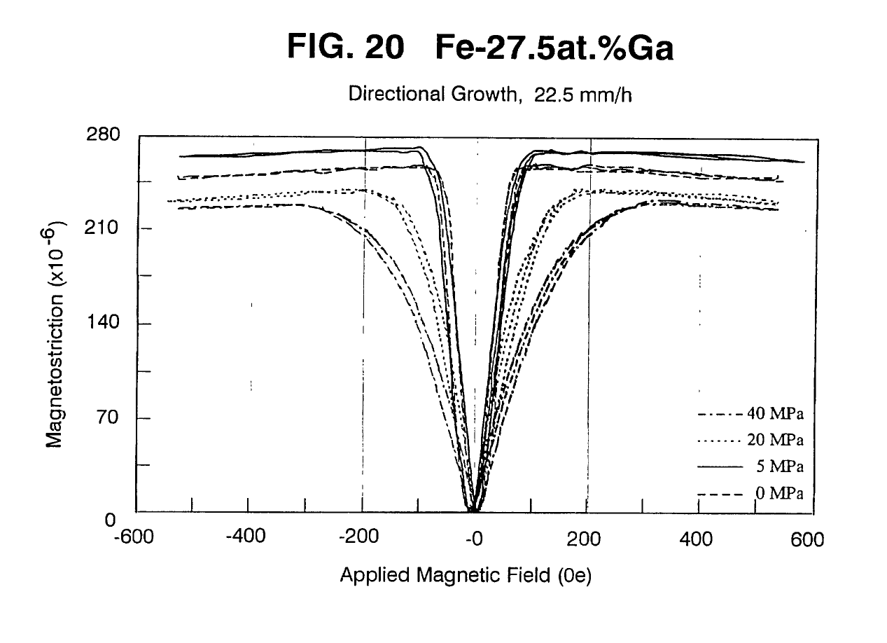

FIG. 17 shows magnetostriction observed at different prestress levels in Fe-15 at % Ga DG alloy rods grown at a rate of 22.5 mm/h. The magnetic filed and stressing are both applied in the direction of the rod-axis. The largest observed value in these experiments was 180×10⁻⁶ at 30 MPa prestress. Increasing Ga content to 20 at % resulted in higher magnetostriction (FIG. 18). The Fe-20 at % Ga DG alloy grown at higher growth rate of 203 mm/h showed even higher magnetostriction but this value tends to drop off at higher magnetic fields as can be seen from FIG. 19. Increasing the Ga content to 27.5 at % in the DG alloys grown at 22.5 mm/h increases the magnetostriction values to 271×10⁻⁶(FIG. 20). With preferred growth direction tending to be between [110] and [100], and closer to [210] (as indicated by preliminary pole figure data obtained from Orientation Imaging Microscopy in SEM), much higher values can be expected if preferred growth direction can be changed from mixed texture to only [100] direction or by obtaining a seeded growth of [100] single crystals. The applied magnetic fields to achieve saturation magnetostriction are less than 100 Oe and the hysteresis is low. Large magnetostriction values at zero prestress levels makes these alloys attractive in the design of actuators and sensors as they eliminate the incorporation of preloading arrangement.

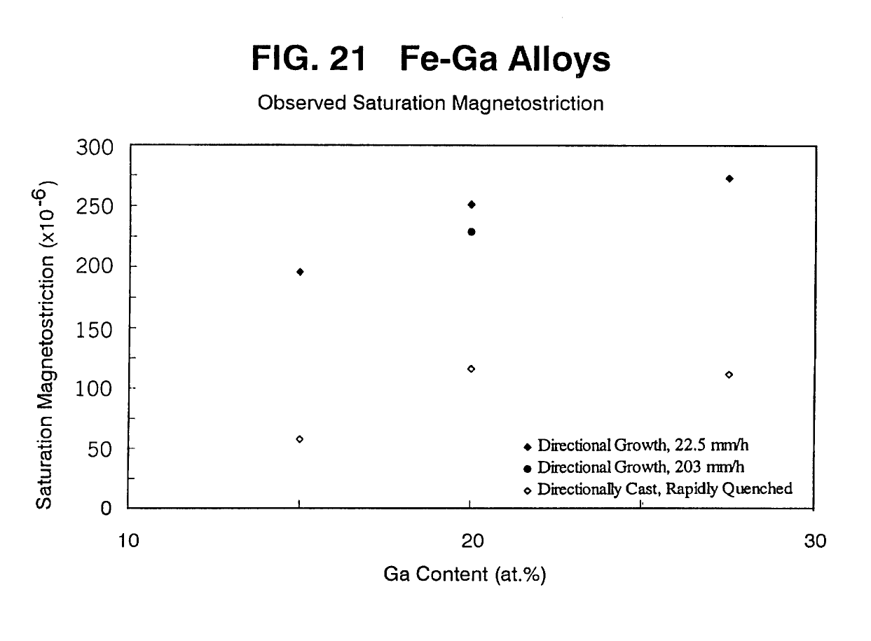

These directionally grown alloys show magnetostriction values along the axis of the rod that are more than twice that observed in DS cast alloys as can be seem from FIG. 21.

Influence of Ordering Treatment on the Magnetostriction of Fe-27.5 at % Ga DG Alloy Rods:

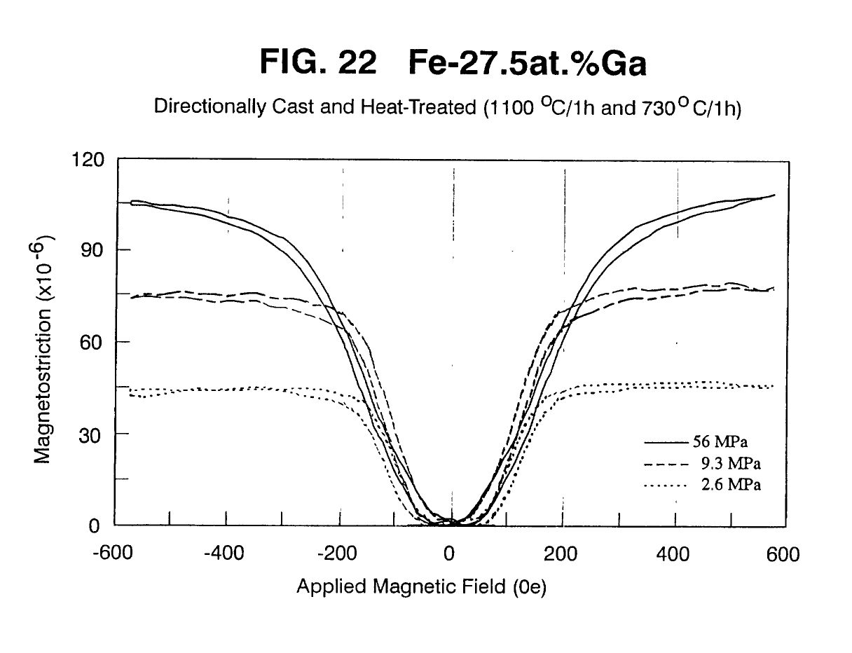

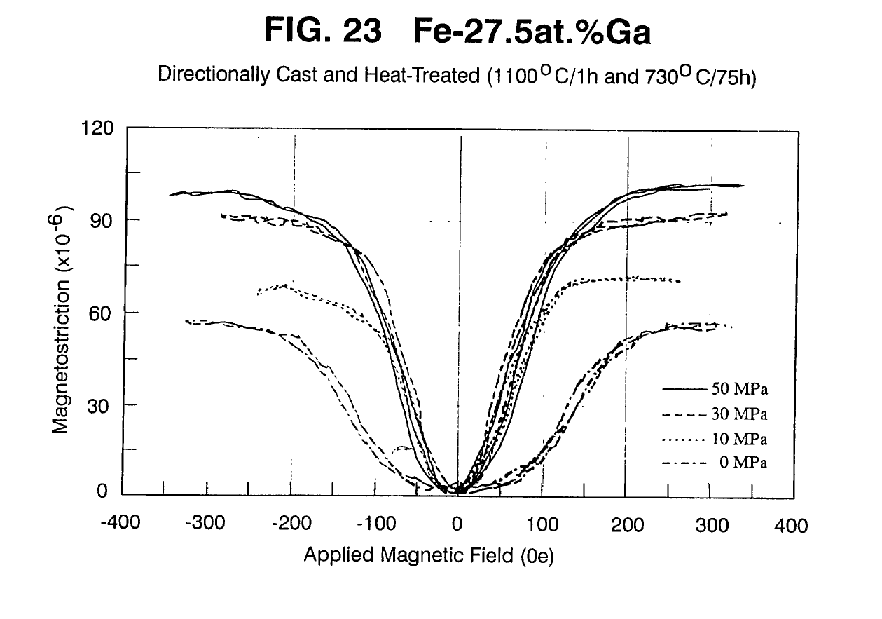

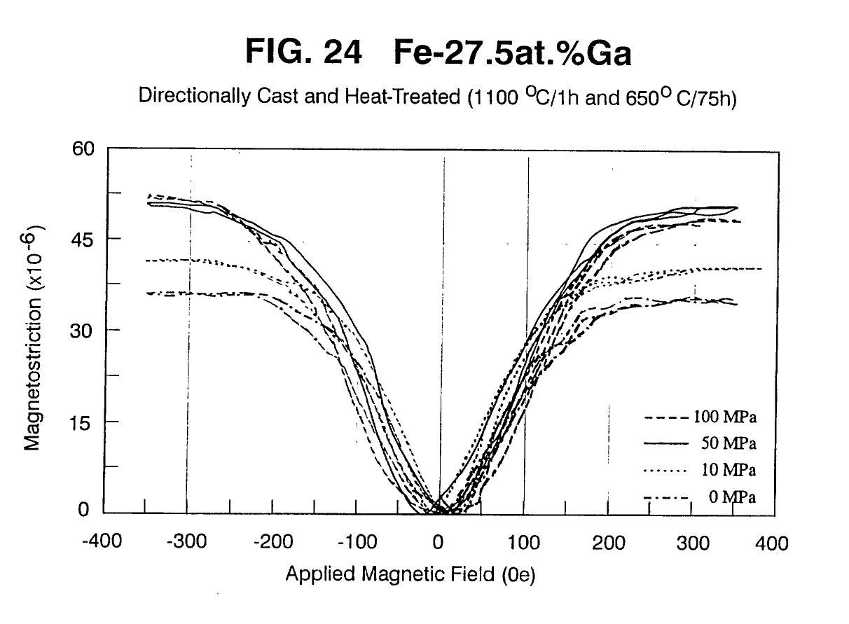

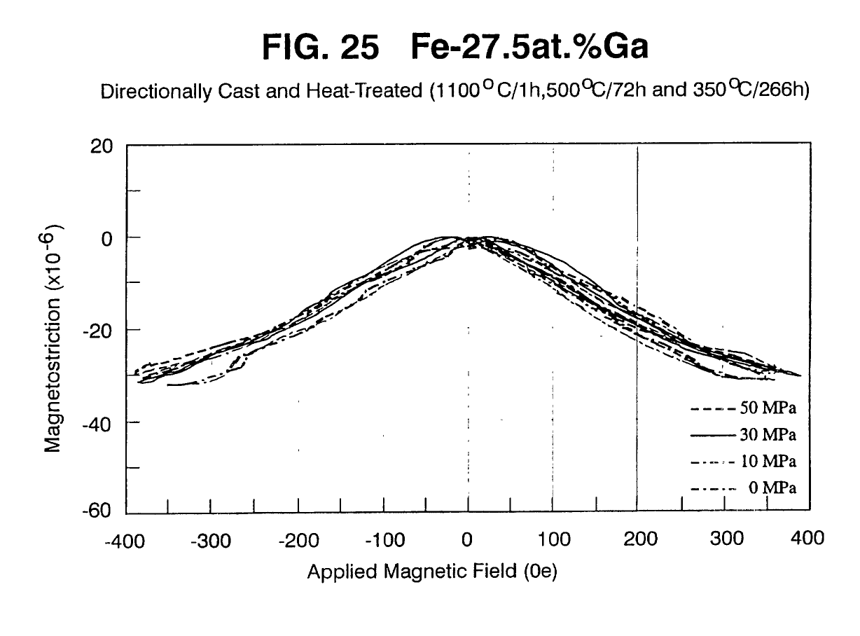

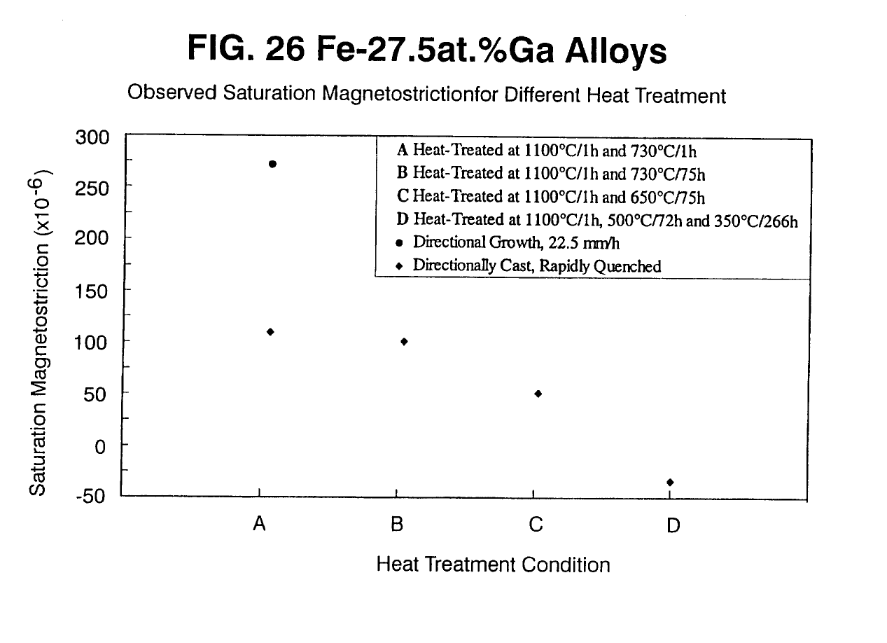

The Fe-27.5 at % Ga alloy can exist in disordered bcc (A2), α″, DO₁₉ and Ll₂ structures. The α″ phase structure has a Fm\overline{3}m symmetry. A2 can be prepared by rapid quenching from 1100° C. in the A2 phase field. Based on the phase diagram suggested by Okamoto and reference, the α″ structure can be obtained by annealing at a temperature of 730° C. followed by rapid quenching (Treatments A and B). The D0₁₉ structure can be obtained by annealing at 650° C. for a long time and rapid-quenching (Treatment C). The Ll₂ structure can be obtained by annealing at 500° C. for long term followed by annealing at a lower temperature of 350° C. to increase the extent of long-range order (Treatment D). The magnetostriction values obtained in Fe-27.5% Ga DS cast alloys after long-range-ordering treatments A through D are shown in FIGS. 22-25 and the data summarized in FIG. 26. It is seen that Treatments A and B provide magnetostriction values along the rod axis that are similar. The treatments C resulting in DO₁₉ structure decreases magnetostriction along the axis of the rod. Treatment D resulting in L1₂ structure further decreases the magnetostriction measured along the axis of the rod.

Influence of Partial Substitution of Al in Fe-20 at % Ga Alloy

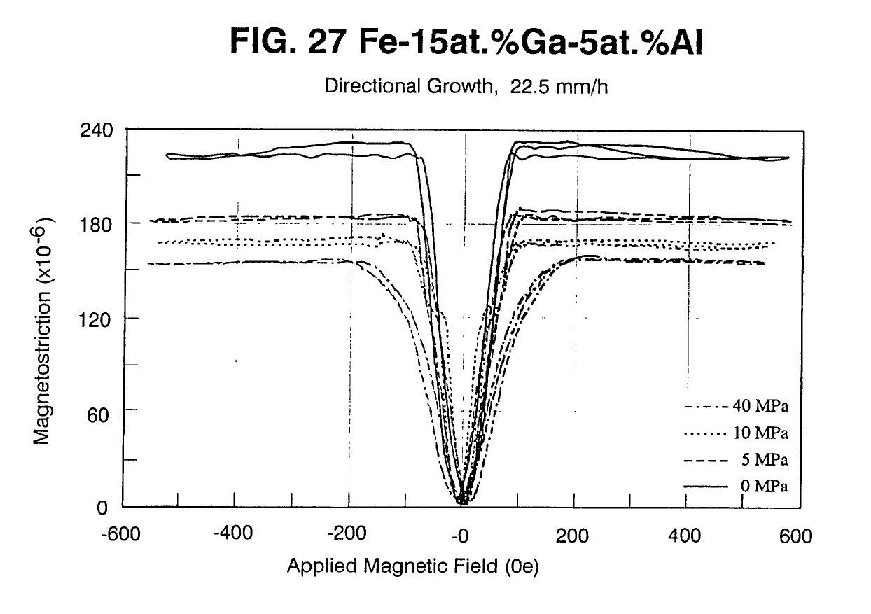

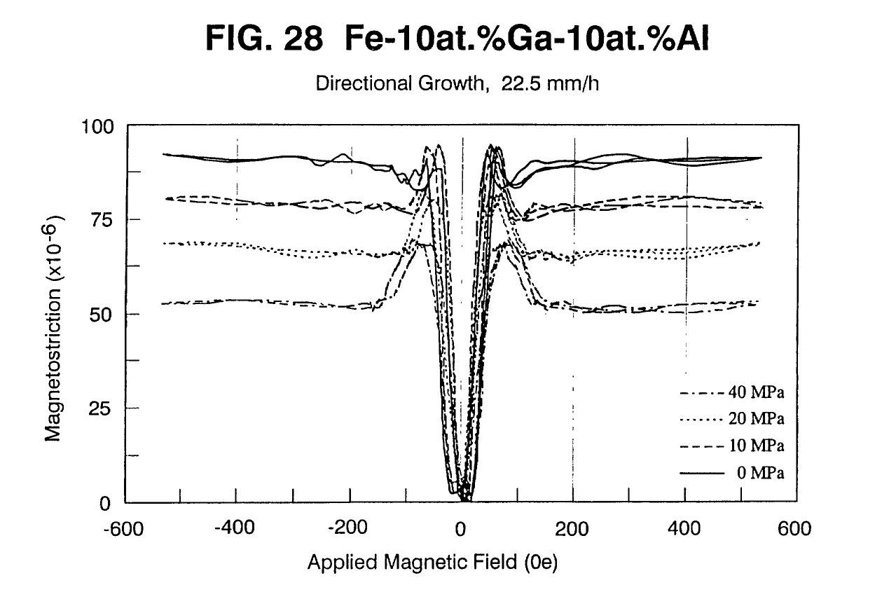

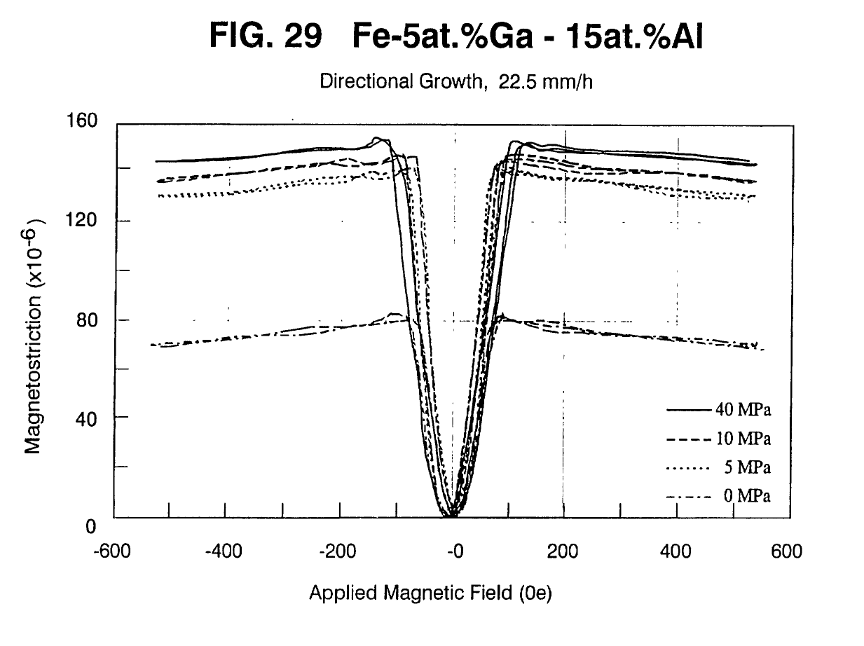

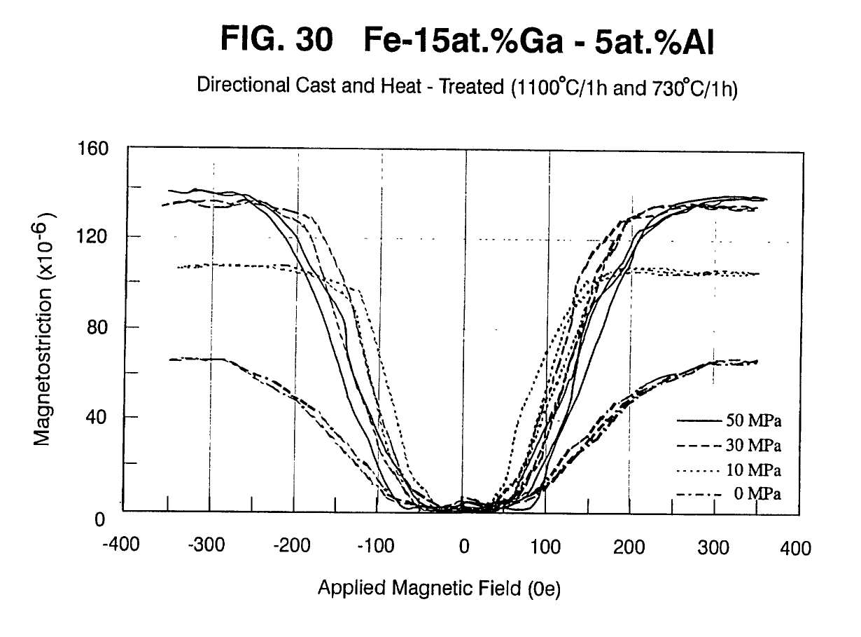

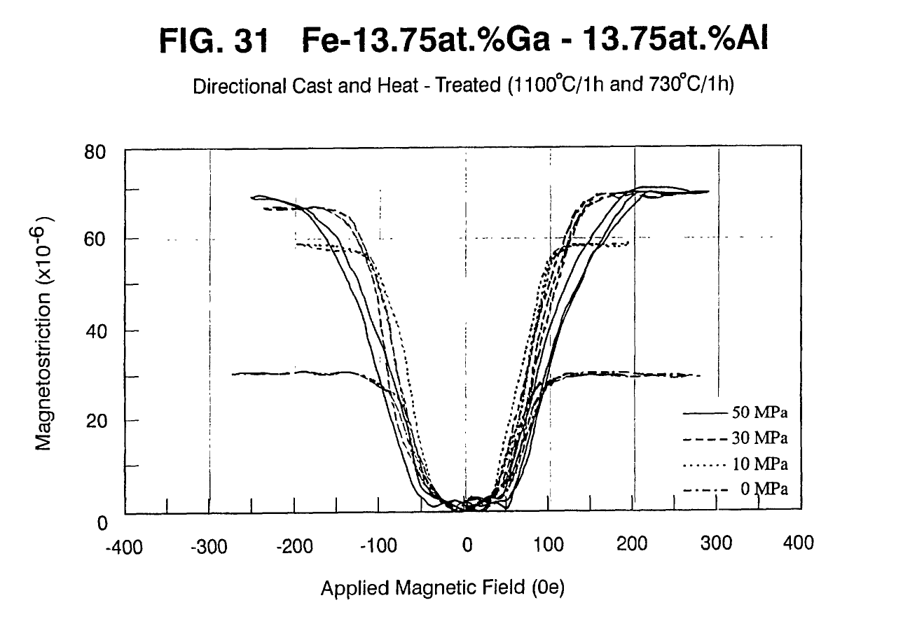

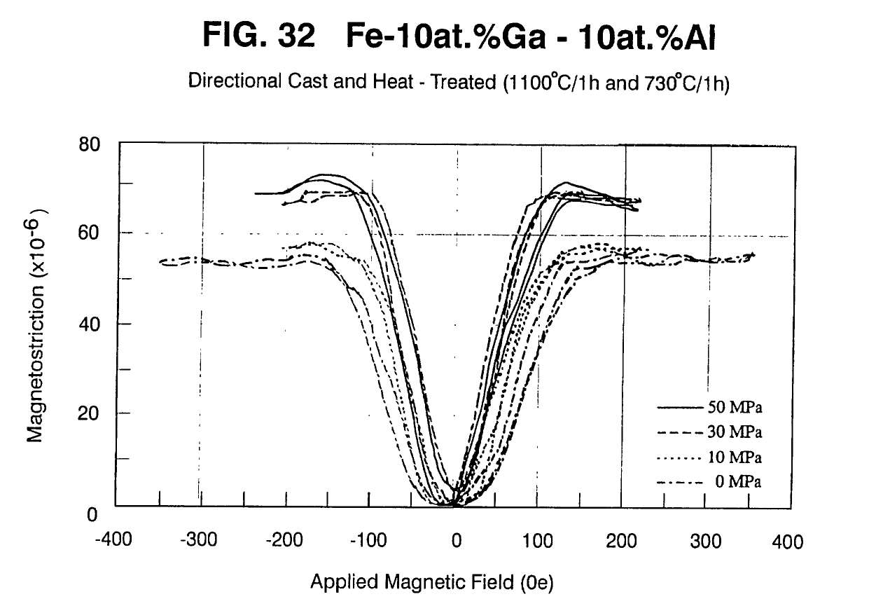

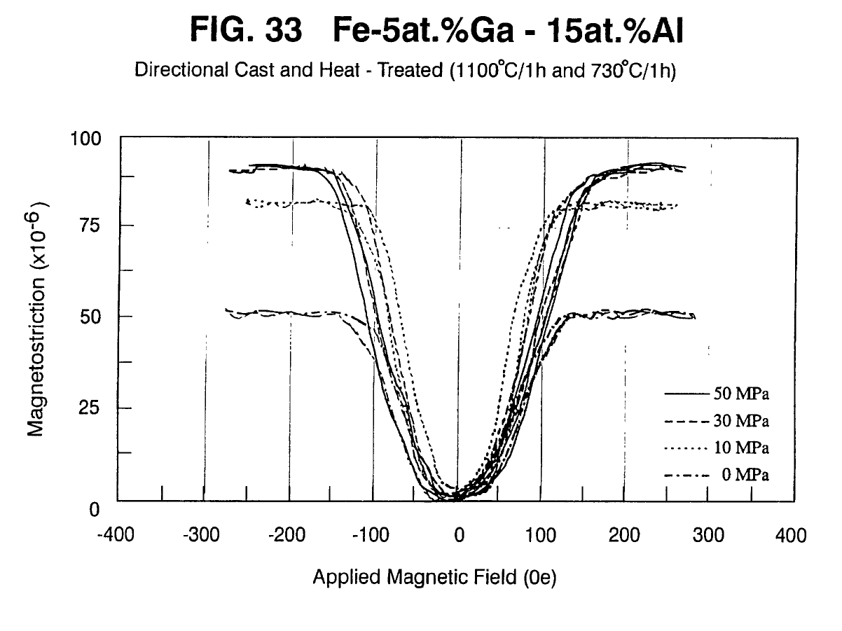

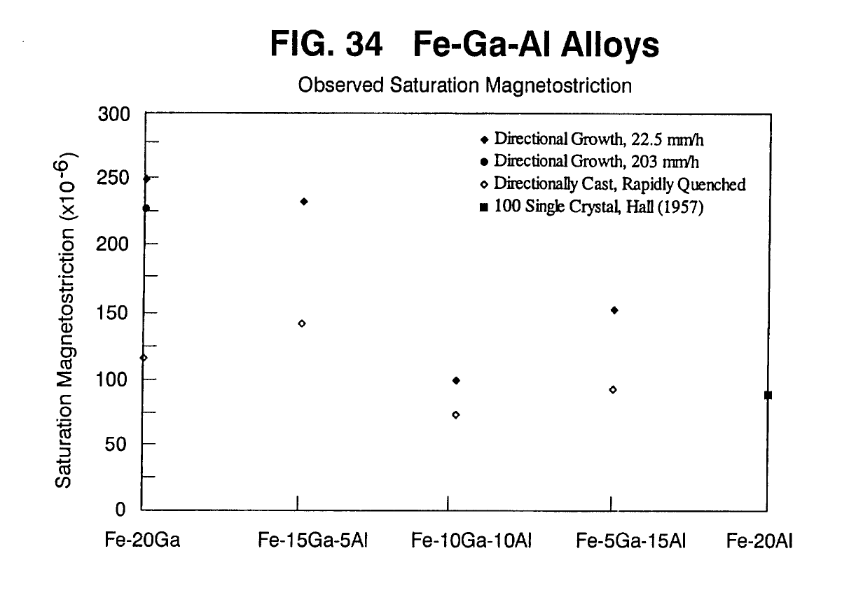

Influence of Al addition to Fe—Ga alloys was examined by substituting Ga in Fe-20 at % Ga alloy with 5, 10, and 15 at % of Al. FIG. 27 shows the magnetostriction curves for Fe-15 at % Ga-5 at % Al DG alloy rod (grown at 22.5 m/h) at different prestress levels. These magnetostriction values along the axis of the rod were similar to or slightly higher than that observed in Fe-20 at % Ga DG alloy rod grown at 22.5 mm/h (FIG. 18). Substitution with 10 at % Al results in a large decrease of magnetostriction as shown by the curves for Fe-10 at % Ga-10 at % Al DG alloy rod grown at 22.5 mm/h (FIG. 28). Surprisingly substitution of 15 at % Al increases the magnetostriction as observed in Fe-5 at %Ga-15 at % Al DG alloy rod grown at 22.5 mm/h (FIG. 29). Similar trends are observed in DS cast alloys (FIGS. 30-33). FIG. 34 summarizes the results of the work on the influence of partial substitution of Ga by Al in Fe—Ga alloys. Thus addition of Ga to Fe—Al alloy or addition of Al to Fe—Ga alloys can be made without a significant loss of magnetostriction in these DG alloys.

### SUMMARY

The alloys of Fe₁₀₀₋ₓGaₓ and Fe_{100-x-y}GaₓAl_{y}, where x and y<30, form the basis of a new class of strong, highly magnetostrictive materials of nominal cost. These alloys are especially suited for a variety of demanding high power transduction and actuator applications, particularly those that are employed in tough or explosive environments. Room temperature single crystal magnetostrains exceed 300 ppm and are only weakly temperature dependent. Magnetizations are ˜1.8 T, magnetic anisotropies are only ˜10⁴ J/m³, and relative permeabilities ˜100. Small amounts of other elements, such as Be, Si, V, Cr. etc. can be added to improve the magnetostriction to anisotropy (λ/K) ratio and magnetomechanical coupling factor (k₃₃). In these materials, saturation magnetostrictions of 400+ ppm and coupling factors ˜0.5 are predicted. Magnetostriction values in textured polycrystalline alloys exceed 150 ppm.

Obviously, many modifications and variations of the present invention are possible in light of the above teachings. It is therefore to be understood that, within the scope of the appended claims, the invention may be practiced otherwise than as specifically described.

What is claimed is:

1. A device for converting magnetic energy into mechanical energy, said device comprising:
a magnetic field generator;
a cubic crystalline alloy subject to a magnetic field generated by said magnetic field generator, said alloy having a room temperature saturation magnetostriction along the [100] axis of at least about 200 ppm and comprising about 70 at % to about 90 at % Fe and about 5 at % to about 30 at % Ga;
said mechanical energy being in the form of a change of dimension of said alloy.

2. The device of claim 1, wherein said alloy comprises about 10 at % to about 25 at % Ga.

3. The device of claim 2, wherein said alloy comprises about 15 at % to about 22 at % Ga.

4. The device of claim 1, wherein said alloy further comprises Al.

5. The device of claim 1, wherein said alloy is a single crystal.

6. A device for converting mechanical energy into electrical energy, comprising:
a cubic crystalline alloy having a room temperature saturation magnetostriction along the [100] axis of at least about 200 ppm, said alloy comprising about 70 at % to about 90 at % Fe, about 5 at % to about 30 at % Ga;
an electrically conductive coil inductively coupled to said alloy.

7. The device of claim 6, wherein said alloy comprises about 10 at % to about 25 at % Ga.

8. The device of claim 7, wherein said alloy comprises about 15 at % to about 22 at % Ga.

9. The device of claim 6, wherein said alloy further comprises Al.

10 The device of claim 6, wherein said alloy is a single crystal.

11. A method of converting magnetic energy into mechanical energy, comprising the step of subjecting a cubic crystalline alloy having a room temperature saturation magnetostriction along the [100] axis of at least about 200 ppm, said alloy comprising about 70 at % to about 90 at % Fe and about 5 at % to about 30 at % Ga to a change in magnetic field.

12. The method of claim 11, wherein said alloy comprises about 10 at % to about 25 at % Ga.

13. The method of claim 12, wherein said alloy comprises about 15 at % to about 22 at % Ga.

14. The method of claim 11, wherein said alloy further comprises Al.

15. The method of claim 11, wherein said alloy is a single crystal.

16 A method of converting mechanical energy into magnetic energy, comprising the steps of subjecting a cubic crystalline alloy having a room temperature saturation magnetostriction along the [100] axis of at least about 200 ppm, said alloy comprising about 70 at % to about 90 at % Fe and about 5 at % to about 30 at % Ga.

17. The method of claim 16, wherein said alloy comprises about 10 at % to about 25 at % Ga.

18. The method of claim 17, wherein said alloy comprises about 15 at % to about 22 at % Ga.

19. The method of claim 16, wherein said alloy further comprises Al.

20. The method of claim 16, wherein said alloy is a single crystal.

21 A device according to claim 1, wherein said alloy is polycrystalline.

22. A device according to claim 6, wherein said alloy is polycrystalline.

23. The method of claim 11, wherein said alloy is polycrystalline.

24. The method of claim 16, wherein said alloy is polycrystalline.

25. A method of producing a producing a polycrystalline alloy having a room temperature saturation magnetostriction of at least about 200 ppm:
initially warm rolling an alloy comprising about 70 at % to about 90 at % Fe, about 5 at % to about 30 at % Ga at a temperature of about 350° C. to about 550° C. to a reduction of about 22% to about 65%;
intermediately annealing said initially warm rolled alloy at a temperature of about 1050° C. to about 1150° C.;
warm rolling said intermediately annealed alloy at a temperature of about 350° C. to about 550° C. to a reduction of about 22% to about 65% to produce a twice warm rolled alloy;
finally annealing said twice warm rolled alloy at a temperature of about 1150° C. to about 1300° C.

26. The method of claim 26, wherein said alloy further comprises an amount of a texturing agent effective to control grain growth and favor development of a [001] or [100] orientation.
